(19) United States
(12) Patent Application Publication
(10) Pub. No.: US 2008/0155571 A1
(43) Pub. Date: Jun. 26, 2008

(54) Method and System for Host Software Concurrent Processing of a Network Connection Using Multiple Central Processing Units

(76) Inventors: Yuval Kenan, Ben Shemen (IL); Merav Sicron, Kfar Sava (IL); Eliezer Aloni, Zur Yigal (IL)

Correspondence Address: MCANDREWS HELD & MALLOY, LTD, 500 WEST MADISON STREET, SUITE 3400, CHICAGO, IL, 60661, US

(21) Appl. No.: 11/962,869

(22) Filed: Dec. 21, 2007

Related U.S. Application Data
(60) Provisional application No. 60/871,265, filed on Dec. 21, 2006.
(60) Provisional application No. 60/973,629, filed on Sep. 19, 2007.

(51) Int. Cl. G06F 9/54

(52) U.S. Cl. 719/326

(57) ABSTRACT

Certain aspects of a method and system for host software concurrent processing of a network connection using multiple central processing units (CPUs) may be disclosed. Exemplary aspects of the method may include a network system comprising a plurality of processors and a NIC. After completion of one or more received I/O requests, a plurality of completions may be distributed among two or more of the plurality of CPUs. The plurality of CPUs may be enabled to handle processing for one or more network connections and each network connection may be associated with a plurality of completion queues. Each CPU may be associated with at least one global event queue.

### CROSS-REFERENCE TO RELATED APPLICATIONS/INCORPORATION BY REFERENCE

This application makes reference to, claims priority to, and claims benefit of U.S. Provisional Application Ser. No. 60/871,265, filed Dec. 21, 2006 and U.S. Provisional Application Ser. No. 60/973,629, filed Sep. 19, 2007.

The above stated applications are incorporated herein by reference in their entirety.

### FIELD OF THE INVENTION

Certain embodiments of the invention relate to network interfaces. More specifically, certain embodiments of the invention relate to a method and system for host software concurrent processing of a network connection using multiple central processing units (CPUs).

### BACKGROUND OF THE INVENTION

Hardware and software may often be used to support asynchronous data transfers between two memory regions in data network connections, often on different systems. Each host system may serve as a source (initiator) system which initiates a message data transfer (message send operation) to a target system of a message passing operation (message receive operation). Examples of such a system may include host servers providing a variety of applications or services and I/O units providing storage oriented and network oriented I/O services. Requests for work, for example, data movement operations including message send/receive operations and remote direct memory access (RDMA) read/write operations may be posted to work queues associated with a given hardware adapter, the requested operation may then be performed. It may be the responsibility of the system which initiates such a request to check for its completion. In order to optimize use of limited system resources, completion queues may be provided to coalesce completion status from multiple work queues belonging to a single hardware adapter. After a request for work has been performed by system hardware, notification of a completion event may be placed on the completion queue. The completion queues may provide a single location for system hardware to check for multiple work queue completions.

The completion queues may support one or more modes of operation. In one mode of operation, when an item is placed on the completion queue, an event may be triggered to notify the requester of the completion. This may often be referred to as an interrupt-driven model. In another mode of operation, an item may be placed on the completion queue, and no event may be signaled. It may be then the responsibility of the request system to periodically check the completion queue for completed requests. This may be referred to as polling for completions.

Internet Small Computer System Interface (iSCSI) is a TCP/IP-based protocol that is utilized for establishing and managing connections between IP-based storage devices, hosts and clients. The iSCSI protocol describes a transport protocol for SCSI, which operates on top of TCP and provides a mechanism for encapsulating SCSI commands in an IP infrastructure. The iSCSI protocol is utilized for data storage systems utilizing TCP/IP infrastructure.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for host software concurrent processing of a network connection using multiple central processing units (CPUs), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system illustrating an iSCSI storage area network principle of operation that may be utilized in connection with an embodiment of the invention.

FIG. 2 is a block diagram of an exemplary system with a NIC interface, in accordance with an embodiment of the invention.

FIG. 3 is a block diagram illustrating a NIC interface that may be utilized in connection with an embodiment of the invention.

FIG. 4 is a block diagram of an exemplary network system for host software concurrent processing of a single network connection using multiple CPUs, in accordance with an embodiment of the invention.

FIG. 5 is a block diagram of an exemplary network system for host software concurrent processing of a multiple network connections using multiple CPUs, in accordance with an embodiment of the invention.

FIG. 6 is a flowchart illustrating exemplary steps for host software concurrent processing of a network connection using multiple CPUs, in accordance with an embodiment of the invention.

### DETAILED DESCRIPTION OF THE INVENTION

Certain embodiments of the invention may be found in a method and system for host software concurrent processing of a network connection using multiple central processing units (CPUs). Aspects of the method and system may comprise a network system comprising a plurality of processors and a NIC. After completion of one or more received I/O requests, a plurality of completions may be distributed among two or more of the plurality of CPUs. The plurality of CPUs may be enabled to handle processing for one or more network connections and each network connection may be associated with a plurality of completion queues. Each CPU may be associated with at least one global event queue.

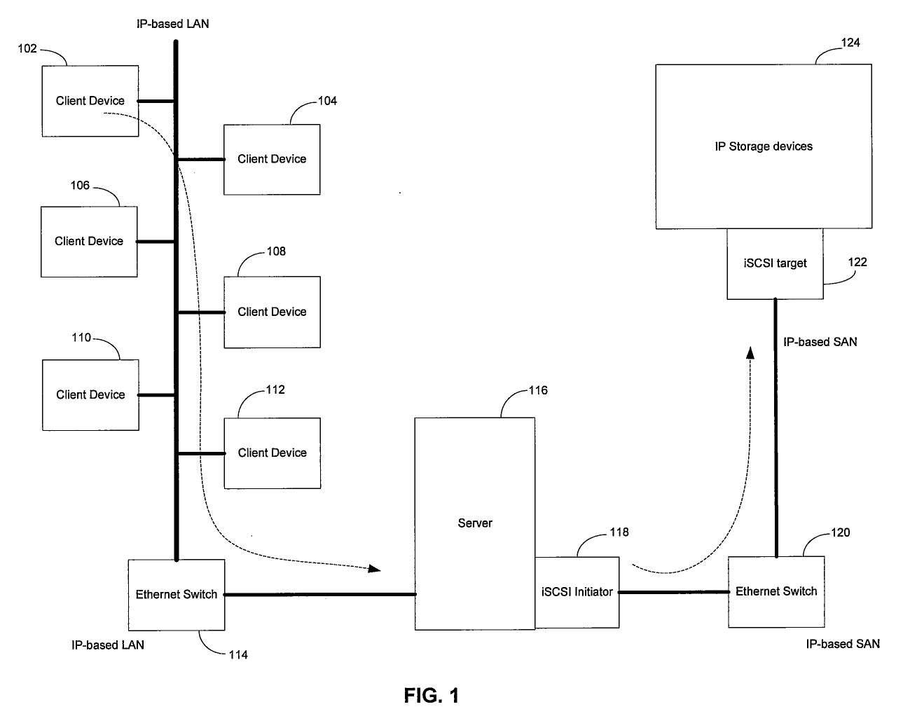

FIG. 1 is a block diagram of an exemplary system illustrating an iSCSI storage area network principle of operation that may be utilized in connection with an embodiment of the invention. Referring to FIG. 1, there is shown a plurality of client devices 102, 104, 106, 108, 110 and 112, a plurality of Ethernet switches 114 and 120, a server 116, an iSCSI initiator 118, an iSCSI target 122 and a storage device 124.

The plurality of client devices 102, 104, 106, 108, 110 and 112 may comprise suitable logic, circuitry and/or code that may be enabled to a specific service from the server 116 and may be a part of a corporate traditional data-processing IP-based LAN, for example, to which the server 116 is coupled. The server 116 may comprise suitable logic and/or circuitry that may be coupled to an IP-based storage area network (SAN) to which IP storage device 124 may be coupled. The server 116 may process the request from a client device that may require access to specific file information from the IP storage devices 124.

The Ethernet switch 114 may comprise suitable logic and/or circuitry that may be coupled to the IP-based LAN and the server 116. The iSCSI initiator 118 may comprise suitable logic and/or circuitry that may be enabled to receive specific SCSI commands from the server 116 and encapsulate these SCSI commands inside a TCP/IP packet(s) that may be embedded into Ethernet frames and sent to the IP storage device 124 over a switched or routed SAN storage network. The Ethernet switch 120 may comprise suitable logic and/or circuitry that may be coupled to the IP-based SAN and the server 116. The iSCSI target 122 may comprise suitable logic, circuitry and/or code that may be enabled to receive an Ethernet frame, strip at least a portion of the frame, and recover the TCP/IP content. The iSCSI target 122 may also be enabled to decapsulate the TCP/IP content, obtain SCSI commands needed to retrieve the required information and forward the SCSI commands to the IP storage device 124. The IP storage device 124 may comprise a plurality of storage devices, for example, disk arrays or a tape library.

The iSCSI protocol may enable SCSI commands to be encapsulated inside TCP/IP session packets, which may be embedded into Ethernet frames for transmissions. The process may start with a request from a client device, for example, client device 102 over the LAN to the server 116 for a piece of information. The server 116 may be enabled to retrieve the necessary information to satisfy the client request from a specific storage device on the SAN. The server 116 may then issue specific SCSI commands needed to satisfy the client device 102 and may pass the commands to the locally attached iSCSI initiator 118. The iSCSI initiator 118 may encapsulate these SCSI commands inside one or more TCP/IP packets that may be embedded into Ethernet frames and sent to the storage device 124 over a switched or routed storage network.

The ISCSI target 122 may also be enabled to decapsulate the packet, and obtain the SCSI commands needed to retrieve the required information. The process may be reversed and the retrieved information may be encapsulated into TCP/IP segment form. This information may be embedded into one or more Ethernet frames and sent back to the iSCSI initiator 118 at the server 116, where it may be decapsulated and returned as data for the SCSI command that was issued by the server 116. The server 116 may then complete the request and place the response into the IP frames for subsequent transmission over a LAN to the requesting client device 102.

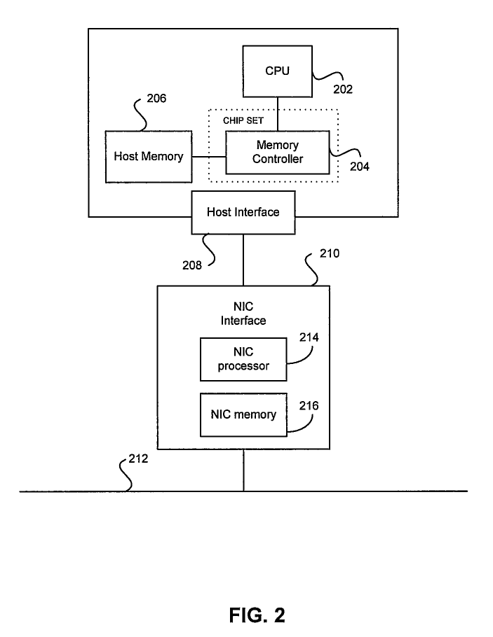

FIG. 2 is a block diagram of an exemplary system with a NIC interface, in accordance with an embodiment of the invention. Referring to FIG. 2, the system may comprise a CPU 202, a memory controller 204, a host memory 206, a host interface 208, NIC interface 210 and an Ethernet bus 212. The NIC interface 210 may comprise a NIC processor 214 and NIC memory 216. The host interface 208 may be, for example, a peripheral component interconnect (PCI), PCI-X, PCI-Express, ISA, SCSI or other type of bus. The memory controller 206 may be coupled to the CPU 204, to the memory 206 and to the host interface 208. The host interface 208 may be coupled to the NIC interface 210. The NIC interface 210 may communicate with an external network via a wired and/or a wireless connection, for example. The wireless connection may be a wireless local area network (WLAN) connection as supported by the IEEE 802.11 standards, for example.

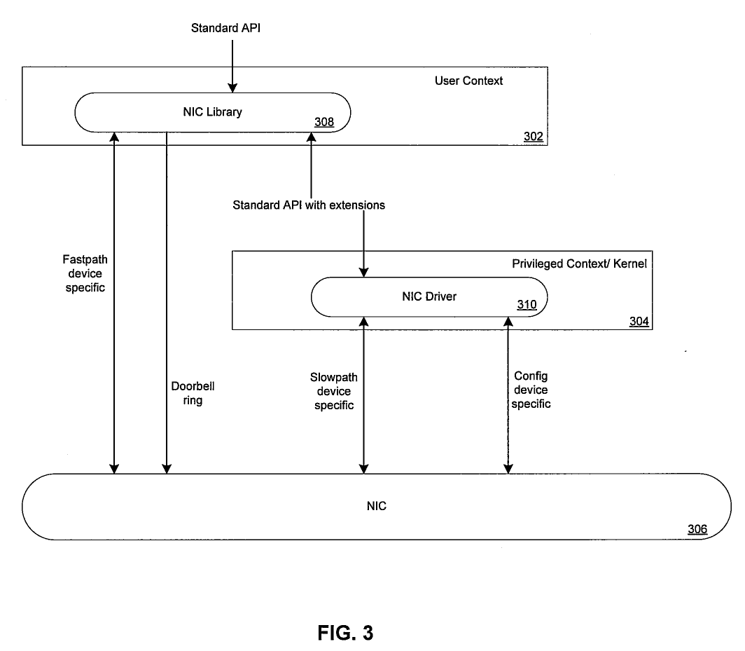

FIG. 3 is a block diagram illustrating a NIC interface that may be utilized in connection with an embodiment of the invention. Referring to FIG. 3, there is shown a user context block 302, a privileged context/kernel block 304 and a NIC 306. The user context block 302 may comprise a NIC library 308. The privileged context/kernel block 304 may comprise a NIC driver 310.

The NIC library 308 may be coupled to a standard application programming interface (API). The NIC library 308 may be coupled to the NIC 306 via a direct device specific fastpath. The NIC library 308 may be enabled to notify the NIC 306 of new data via a doorbell ring. The NIC 306 may be enabled to coalesce interrupts via an event ring.

The NIC driver 310 may be coupled to the NIC 306 via a device specific slowpath. The slowpath may comprise memory-mapped rings of commands, requests, and events, for example. The NIC driver 310 may be coupled to the NIC 306 via a device specific configuration path (config path). The config path may be utilized to bootstrap the NIC 310 and enable the slowpath.

The privileged context/kernel block 304 may be responsible for maintaining the abstractions of the operating system, such as virtual memory and processes. The NIC library 308 may comprise a set of functions through which applications may interact with the privileged context/kernel block 304. The NIC library 308 may implement at least a portion of operating system functionality that may not need privileges of kernel code. The system utilities may be enabled to perform individual specialized management tasks. For example, a system utility may be invoked to initialize and configure a certain aspect of the OS. The system utilities may also be enabled to handle a plurality of tasks such as responding to incoming network connections, accepting logon requests from terminals, or updating log files.

The privileged context/kernel block 304 may execute in the processor’s privileged mode as kernel mode. A module management mechanism may allow modules to be loaded into memory and to interact with the rest of the privileged context/kernel block 304. A driver registration mechanism may allow modules to inform the rest of the privileged context/kernel block 304 that a new driver is available. A conflict resolution mechanism may allow different device drivers to reserve hardware resources and to protect those resources from accidental use by another device driver.

When a particular module is loaded into privileged context/kernel block 304, the OS may update references the module makes to kernel symbols, or entry points to corresponding locations in the privileged context/kernel block's 304 address space. A module loader utility may request the privileged context/kernel block 304 to reserve a continuous area of virtual kernel memory for the module. The privileged context/kernel block 304 may return the address of the memory allocated, and the module loader utility may use this address to relocate the module's machine code to the corresponding loading address. Another system call may pass the module and a corresponding symbol table that the new module wants to export, to the privileged context/kernal block 304. The module may be copied into the previously allocated space, and the privileged context/kernal block's 304 symbol table may be updated with the new symbols.

The privileged context/kernal block 304 may maintain dynamic tables of known drivers, and may provide a set of routines to allow drivers to be added or removed from these tables. The privileged context/kernal block 304 may call a module's startup routine when that module is loaded. The privileged context/kernal block 304 may call a module's cleanup routine before that module is unloaded. The device drivers may include character devices such as printers, block devices and network interface devices.

A notification of one or more completions may be placed on at least one of the plurality of fast path completion queues per connection after completion of the I/O request. An entry may be posted to at least one global event queue based on the placement of the notification of one or more completions posted to the fast path completion queues or slow path completions per CPU.

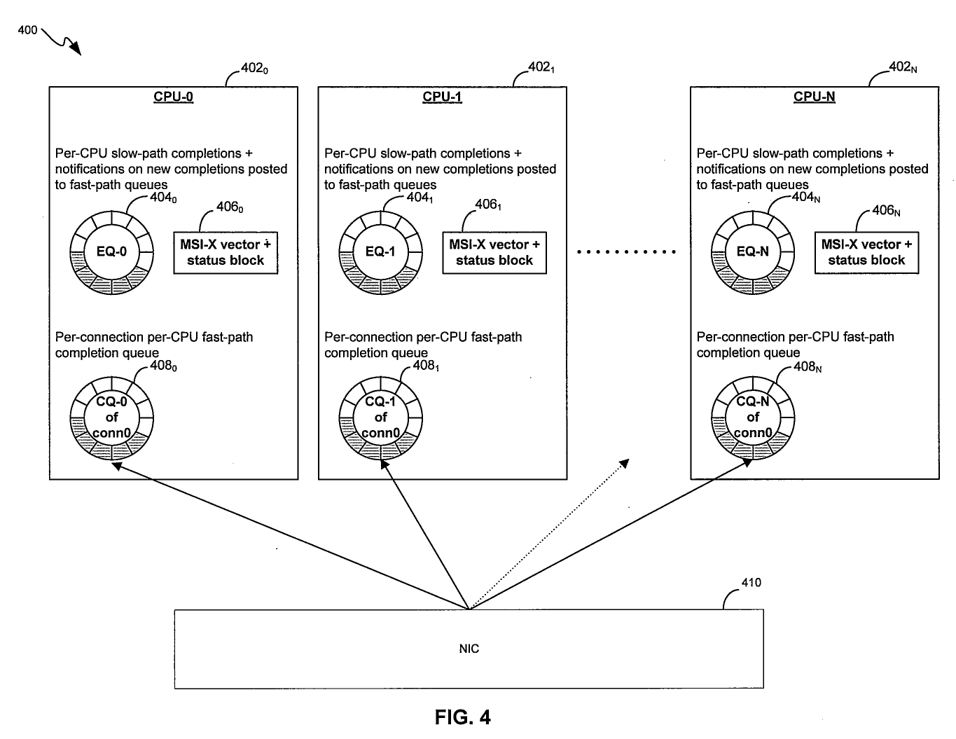

FIG. 4 is a block diagram of an exemplary network system for host software concurrent processing of a single network connection using multiple CPUs, in accordance with an embodiment of the invention. Referring to FIG. 4, there is shown a network system 400. The network system 400 may comprise a plurality of interconnected processors or central processing units (CPUs), CPU-0 402₀, CPU-1 402₁. . . CPU-N 402_{N} and a NIC 410. Each CPU may comprise an event queue (EQ), a MSI-X interrupt and status block, and a completion queue (CQ) associated with a particular connection. For example, CPU-0 402₀ may comprise an EQ-0 404₀, a MSI-X vector and status block 406₀, and a CQ-0 for connection-0 408₀. Similarly, CPU-1 402₁ may comprise an EQ-1 404₁, a MSI-X vector and status block 406₁, and a CQ-1 for connection-0 408₁. CPU-N 402_{N} may comprise an EQ-N 404_{N}, a MSI-X vector and status block 406_{N}, and a CQ-N for connection-0 408_{N}.

Each event queue (EQ), for example, EQ-0 404₀, EQ-1 404₁. . . EQ-N 404_{N} may be enabled to queue events from underlying peers and from trusted applications. Each event queue, for example, EQ-0 404₀, EQ-1 404₁. . . EQ-N 404_{N} may be enabled to encapsulate asynchronous event dispatch machinery which may extract events from the queue and dispatch them. In one embodiment of the invention, the EQ, for example, EQ-0 404₀, EQ-1 404₁. . . EQ-N 404_{N} may be enabled to dispatch or process events sequentially or in the same order as they are enqueued.

The plurality of MSI-X and status blocks for each CPU, for example, MSI-X vector and status block 406₀, 406₁. . . 406_{N} may comprise one or more extended message signaled interrupts (MSI-X). The message signaled interrupts (MSIs) may be in-band messages that may target an address range in the host bridge unlike fixed interrupts. Since the messages are in-band, the receipt of the message may be utilized to push data associated with the interrupt. Each of the MSI messages assigned to a device may be associated with a unique message in the CPU, for example, a MSI-X in the MSI-X and status block 406₀ may be associated with a unique message in the CPU-0 402₀. The PCI functions may request one or more MSI messages. In one embodiment of the invention, the host software may allocate fewer MSI messages to a function than the function requested.

Extended MSI (MSI-X) may comprise the capability to enable a function to allocate more messages, for example, up to 2048 messages by making the address and data value used for each message independent of any other MSI-X message. The MSI-X may also enable software to choose to use the same MSI address and/or data value in multiple MSI-X slots, for example, when the system allocates fewer MSI-X messages to the device than the device requested.

In an exemplary embodiment of the invention, the MSI-X interrupts may be edge triggered since the interrupt may be signaled with a posted write command by the device targeting a pre-allocated area of memory on the host bridge. However, some host bridges may have the ability to latch the acceptance of an MSI-X message and may effectively treat it as a level signaled interrupt. The MSI-X interrupts may enable writing to a segment of memory instead of asserting a given IRQ pin. Each device may have one or more unique memory locations to which MSI-X messages may be written. The MSI interrupts may enable data to be pushed along with the MSI event, allowing for greater functionality. The MSI-X interrupt mechanism may enable the system software to configure each vector with an independent message address and message data that may be specified by a table that may reside in host memory. The MSI-X mechanism may enable the device functions to support two or more vectors, which may be configured to target different CPUs to increase scalability.

The plurality of completion queues associated with a single connection, connection-0, for example, CQ-0 408₀, CQ-1 408₁. . . CQ-N 408_{N} may be provided to coalesce completion status from multiple work queues belonging to NIC 410. The completion queues may provide a single location for NIC 410 to check for multiple work queue completions. The NIC 410 may be enabled to place a notification of one or more completions on at least one of the plurality of completion queues per connection, for example, CQ-0 for connection-0 408₀, CQ-1 for connection-0 408₁. . . , CQ-N for connection-0 408_{N} after completion of one or more received I/O requests.

In accordance with an embodiment of the invention, a SCSI construct may be blended on an iSCSI layer so that it may be encapsulated inside TCP data before it is transmitted to the hardware for data acceleration. A plurality of read and write operations may be performed to transfer a block of data from an initiator to a target. The read operation may comprise information, which may describe an address of a location where the received data may be placed. The write operation may describe the address of the location from which the data may be transferred. A SCSI request list may comprise a set of command descriptor blocks (CDBs) for read and write operations and each CDB may be associated with a corresponding buffer.

In accordance with an embodiment of the invention, host software performance enhancement for a single network connection may be achieved in a multi-CPU system by distributing the completions between the plurality of CPUs, for example, CPU-0 402₀, CPU-1 402₁. . . CPU-N 402_{N}. In another embodiment, an interrupt handler may be enabled to queue the plurality of events on deferred procedure calls (DPCs) of the plurality of CPUs, for example, CPU-0 402₀, CPU-1 402₁. . . CPU-N 402_{N} to achieve host software performance enhancement for a single network connection. The plurality of DPC completion routines of the stack may be performed for a plurality of received I/O requests concurrently on the plurality of CPUs, for example, CPU-0 402₀, CPU-1 402₁. . . CPU-N 402_{N}. The plurality of DPC completion routines may include a logical unit number (LUN) lock or a file lock, for example, but may not include a session lock or a connection lock. In another embodiment of the invention, the single network connection may support a plurality of LUNs and the applications may be concurrently processed on the plurality of CPUs, for example, CPU-0 402₀, CPU-1 402₁. . . CPU-N 402_{N}.

In another embodiment of the invention, concurrency on the host bus adapter (HBA) completion routine may not be enabled as the HBA may receive the session lock. The HBA may be enabled to update session-wide parameters in the completion routine, for example, maximum command sequence number (MaxCmdSn) and initiator task tag (ITT) allocation table. If each CPU, for example, CPU-0 402₀, CPU-1 402₁. . . CPU-N 402_{N} had only a single completion queue, the same CPU may be interrupted, and the DPC completion routines of the plurality of received I/O requests may be performed on the same CPU.

In another embodiment of the invention, each CPU may comprise a plurality of completion queues and the plurality of completions may be distributed between the plurality of CPUs, for example, CPU-0 402₀, CPU-1 402₁. . . CPU-N 402_{N} so that there is a decrease in the amount of cache misses.

In accordance with an embodiment of the invention, in the case of per-LUN CQ processing, each LUN may be associated with a specific CQ and accordingly with a specific CPU. For example, CPU-0 402₀ may comprise a CQ-0 for connection-0 408₀, CPU-1 402₁ may comprise a CQ-1 for connection-0 408₁. . . CPU-N 402_{N} may comprise a CQ-N for connection-0 408_{N}. A plurality of received I/O requests associated with a particular LUN may be completed on the same CQ. In one embodiment of the invention, a specific CQ, for example, CQ-0 for connection-0 408₀ may be associated with several LUNs, for example. Accordingly, a task completion database associated with each LUN may be accessed by the same CPU, for example, CPU-0 402₀ and may accordingly increase the probability that the particular task completion is in its cache when required for a completion operation associated with a particular LUN.

In accordance with another embodiment of the invention, in the case of CPU affinity, each task may be completed on the same CPU where the task was started. For example, a task that started on CPU-0 402₀ may be completed on the same CPU, for example, 402₀ and may accordingly increase the probability that the task completion database is in its cache when required for task completion.

In accordance with an embodiment of the invention, the completions of iSCSI-specific responses and the completions for unsolicited protocol data units (PDUs) may be posted to CQ-0 for connection-0 408₀, for example. The completions may include one or more of a login response, a logout response, a text response, a no operation (NOP-in) response, an asynchronous message, an unsolicited NOP-in request and a reject, for example.

The HBA driver may indicate the location of a particular CQ to the firmware where the task completion of each solicited response may be posted. Accordingly, the LUN database may be placed in a location other than the hardware. The plurality of unsolicited PDUs may be posted by the hardware to CQ-0 for connection-0 408₀, for example. The order of responses issued by the iSCSI target 122 may not be preserved since the completions of a single connection may be distributed among a plurality of CQs and may be processed by a plurality of CPUs, for example, CPU-0 402₀, CPU-1 402₁. . . CPU-N 402_{N}. The ordering of responses may not be expected across SCSI responses, but the ordering of responses may be required for a particular class of responses that may be referred to as fenced responses, for example. When a fenced response is received, the HBA may be enabled to determine whether the received responses that were chronologically received before the fenced response are completed to the upper layer before the fenced response is completed. The HBA may also be enabled to determine whether the received responses that were chronologically received after the fenced response are completed to the upper layer after the fenced response is completed.

When an iSCSI session is composed of multiple connections, the response PDUs, for example, task responses or task management function (TMF) responses originating in the target SCSI layer may be distributed onto the multiple connections by the target iSCSI layer according to iSCSI connection allegiance rules. This process generally may not preserve the ordering of the responses by the time they are delivered to the initiator SCSI layer.

In the case of per-LUN CQ processing, the ordering for the initiator to target link (I_T_L) nexus may be preserved. If an unsolicited NOP-in response is received, the unsolicited NOP-in response may include a valid LUN field, and may be completed in order for that particular LUN. The NOP-in response may be completed on CQ-0 for connection-0 408₀ and the ordering may not be preserved and an unsolicited NOP-in response may be referred to as a fenced completion, for example. If the iSCSI target 122 sends a specific response, and then sends a NOP-in response requesting an echo to ensure that the specific response has arrived, the iSCSI initiator 118 may first process the specific response and then process the NOP-in response. If the iSCSI target 122 sends a specific response, but does not send a NOP-in response requesting an echo to ensure that the specific response has arrived, the iSCSI initiator 118 may not acknowledge the specific response status sequence number (StatSn) to the iSCSI target 122.

In the case of CPU affinity, the ordering for the I_T_L nexus ordering may not be preserved. A particular response may be referred to as a fenced response in the following list of cases. A flag, for example, response fence flag may be set to indicate a fenced response. For example, in the case of a task management function (TMF) response, the plurality of outstanding received I/O requests for the I_T_L nexus identified by the LUN field in the ABORT TASK SET TMF request PDU may be referred to as fenced responses. The plurality of outstanding received I/O requests in the task set for the logical unit identified by the LUN field in the CLEAR TASK SET TMF request PDU may be referred to as fenced responses. The plurality of outstanding received I/O requests from the plurality of initiators for the logical unit identified by the LUN field in the LOGICAL UNIT RESET request PDU may be referred to as fenced responses.

In the case of a SCSI response with sense data, a completion message indicating a unit attention (UA) condition, and a CHECK CONDITION response which may indicate auto contingent allegiance (ACA) establishment since a CHECK CONDITION response may be associated with sense data may be referred to as a fenced response. The first completion message carrying the UA after the multi-task abort on issuing sessions and third-party sessions may be referred to as a fenced response. The TMF response carrying a multi-task TMF response on the issuing session may be referred to as a fenced response. The completion message indicating ACA establishment on the issuing session may be referred to as a fenced response. A SCSI response with ACA active status may be referred to as a fenced response. The TMF response carrying the clear ACA response on the issuing session may be referred to as a fenced response. An unsolicited NOP-in request may be referred to as a fenced response. An asynchronous message PDU may be referred to as a fenced response to ensure that the valid task responses are completed before starting the session recovery. A reject PDU may be referred to as a fenced response to ensure that the valid task responses are completed before starting the session recovery.

When the hardware receives a response which may be referred to as a fenced response, the hardware may indicate it in the CQ entry to the driver, and the driver may be responsible for the correct completion sequence. In one embodiment of the invention, a fenced response completion may be indicated in all the CQs, for example, CQ-0 for connection-0 408₀, CQ-1 for connection-0 408₁. . . CQ-N for connection-0 408_{N}.

There may be a plurality of algorithms to implement the fenced response. In accordance with an embodiment, a sequence number and a fenced completion flag may be utilized to implement a fenced response. In another embodiment, a toggle-bit may be utilized to implement a fenced response. The driver and the hardware may maintain a per-connection toggle-bit. These bits may be reset during initialization. A special toggle flag in the CQ entry may indicate the current value of the toggle-bit in the hardware.

When a fenced response is received, the hardware may invert the value of the toggle-bit. The completion of the fenced response may be duplicated to the plurality of CQs, for example, CQ-0 for connection-0 408₀, CQ-1 for connection-0 408₁. . . CQ-N for connection-0 408_{N}, which may include the value of the toggle-bit after the inversion. When the driver processes a CQ entry, for example, CQ-0 for connection-0 408₀, the driver may compare the toggle flag in the CQ entry to the value of its toggle-bit. If the value of the toggle bit in the CQ entry, for example, CQ-0 for connection-0 408₀, is the same as the value of the driver's toggle bit, a normal completion may be indicated. If the value of the toggle bit in the CQ entry, for example, CQ-0 for connection-0 408₀, is not the same as the value of the driver's toggle bit, a fenced response completion may be indicated. If a fenced response completion is indicated, the driver may be enabled to scan the plurality of CQs, for example, CQ-0 for connection-0 408₀, CQ-1 for connection-0 408₁. . . CQ-N for connection-0 408_{N} and complete the plurality of responses prior to the fenced response completion. The fenced response completion in the plurality of CQs, for example, CQ-0 for connection-0 408₀, CQ-1 for connection-0 408₁. . . CQ-N for connection-0 408_{N} may be identified as the CQ with the toggle flag different than the device driver's toggle-bit. The device driver may be enabled to process and complete the fenced response completion and invert its local toggle-bit. For example, if CQ-0 for connection-0 408₀ in CPU-0 402₀ has the toggle flag that is not the same as the toggle bit in the device driver, then the device driver may be enabled to process and complete the fenced response completion and invert its local toggle-bit. The driver may continue with processing of other CQ entries in the CQ of that CPU, for example, CQ-0 for connection-0 408₀ in CPU-0 402₀.

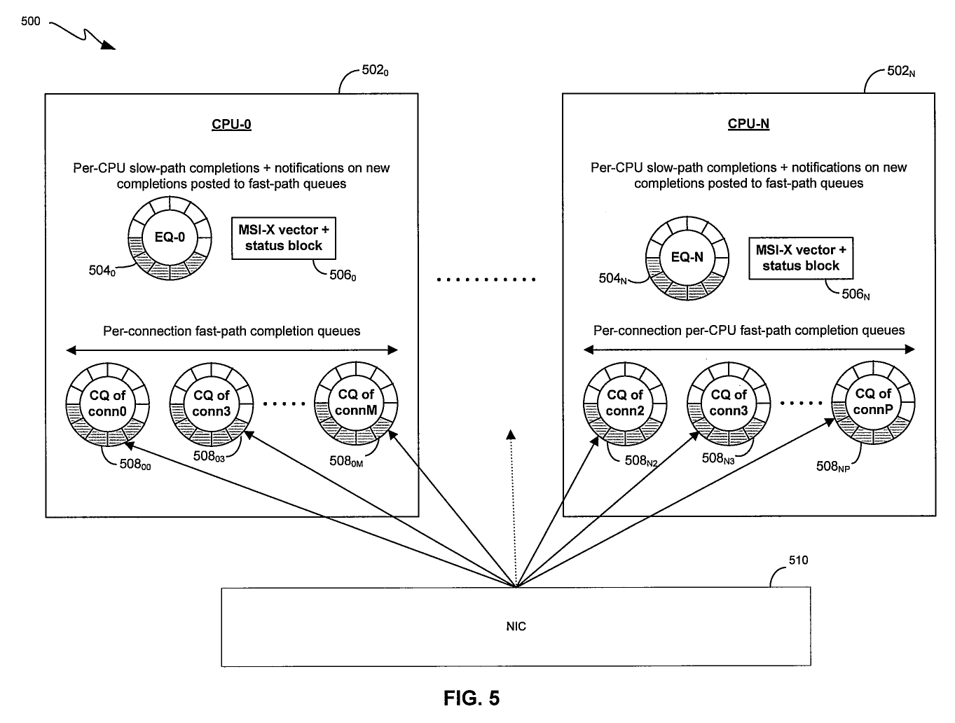

FIG. 5 is a block diagram of an exemplary network system for host software concurrent processing of multiple network connections using multiple CPUs, in accordance with an embodiment of the invention. Referring to FIG. 5, there is shown a network system 500. The network system 500 may comprise a plurality of interconnected processors or central processing units (CPUs), CPU-0 502₀, CPU-1 502₁. . . CPU-N 502_{N} and a NIC 510. Each CPU may comprise an event queue (EQ), a MSI-X interrupt and status block, and a completion queue (CQ) for each network connection. Each CPU may be associated with a plurality of network connections, for example. For example, CPU-0 502₀ may comprise an EQ-0 504₀, a MSI-X vector and status block 506₀, and a CQ for connection-0 508₀₀, a CQ for connection-3 508₀₃. . . , and a CQ for connection-M 508_{0M}. Similarly, CPU-N 502_{N} may comprise an EQ-N 504_{N}, a MSI-X vector and status block 506_{N}, a CQ for connection-2 508_{N2}, a CQ for connection-3 508_{N3}. . . and a CQ for connection-P 508_{NP}.

Each event queue (EQ), for example, EQ-0 504₀, EQ-1 504₁. . . EQ-N 504_{N} may be a plafform-independent class that may be enabled to queue events from underlying peers and from trusted applications. Each event queue, for example, EQ-0 504₀, EQ-1 504₁. . . EQ-N 504_{N} may be enabled to encapsulate asynchronous event dispatch machinery which may extract events from the queue and dispatch them. In one embodiment, the EQ, for example, EQ-0 504₀, EQ-1 504₁. . . EQ-N 504_{N} may be enabled to dispatch or process events sequentially or in the same order as they are enqueued.

The plurality of MSI-X and status blocks for each CPU, for example, MSI-X vector and status block 506₀, 506₁. . . 506_{N} may comprise one or more extended message signaled interrupts (MSI-X). Each MSI message assigned to a device may be associated with a unique message in the CPU, for example, a MSI-X in the MSI-X and status block 506₀ may be associated with a unique message in the CPU-0 502₀.

Each completion queue (CQ) may be associated with a particular network connection. The plurality of completion queues associated with each connection, for example, CQ for connection-0 508₀₀, a CQ for connection-3 508₀₃. . . , and a CQ for connection-M 508_{0M} may be provided to coalesce completion status from multiple work queues belonging to NIC 510. The NIC 510 may be enabled to place a notification of one or more completions on at least one of the plurality of completion queues per connection, for example, CQ for connection-0 508₀₀, a CQ for connection-3 508₀₃. . . , and a CQ for connection-M 508_{0M} after completion of one or more received I/O requests. The completion queues may provide a single location for NIC 510 to check for multiple work queue completions.

In accordance with an embodiment of the invention, host software performance enhancement for multiple network connections may be achieved in a multi-CPU system by distributing the network connections completions between the plurality of CPUs, for example, CPU-0 502₀, CPU-1 502₁. . . CPU-N 502_{N}. In another embodiment, an interrupt handler may be enabled to queue the plurality of events on deferred procedure calls (DPCs) of the plurality of CPUs, for example, CPU-0 502₀, CPU-1 502₁. . . CPU-N 502_{N} to achieve host software performance enhancement for multiple network connections. The plurality of DPC completion routines of the stack may be performed for a plurality of received I/O requests concurrently on the plurality of CPUs, for example, CPU-0 502₀, CPU-1 502₁. . . CPU-N 502_{N}. The plurality of DPC completion routines may comprise a logical unit number (LUN) lock or a file lock, for example, but may not include a session lock or a connection lock. In another embodiment of the invention, the multiple network connections may support a plurality of LUNs and the applications may be concurrently processed on the plurality of CPUs, for example, CPU-0 502₀, CPU-1 502₁. . . CPU-N 502_{N}.

In another embodiment of the invention, the HBA may be enabled to define a particular event queue, for example, EQ-0 504₀ to notify completions related to each network connection. In another embodiment, one or more completions that may not be associated with a specific network connection may be communicated to a particular event queue, for example, EQ-0 504₀.

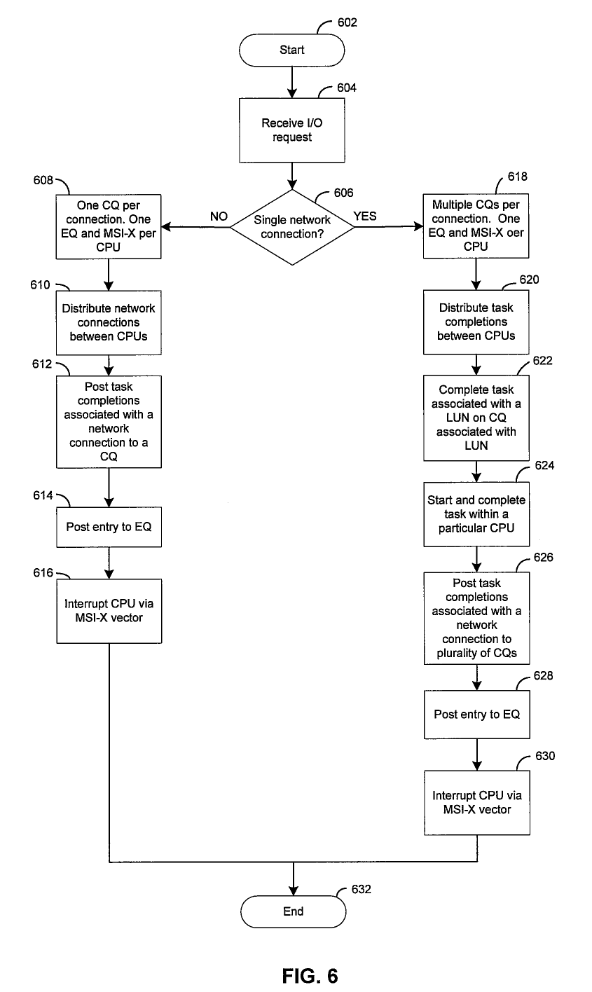

FIG. 6 is a flowchart illustrating exemplary steps for host software concurrent processing of a network connection using multiple CPUs, in accordance with an embodiment of the invention. Referring to FIG. 6, exemplary steps may begin at step 602. In step 604, an I/O request may be received. In step 606, it may be determined whether there is a single network connection. If there are multiple connections, control passes to step 608. In step 608, each network connection may be associated with a single completion queue (CQ). Each CPU may be associated with a single global event queue (EQ) and a MSI-X vector. In step 610, the network connections may be distributed between the plurality of CPUs. In step 612, a plurality of completions associated with a particular network connection may be posted to a particular CQ. In step 614, an entry may be posted to the EQ associated with a particular CPU after completions have been posted to the particular CQ. In step 616, the particular CPU may be interrupted via the MSI-X vector based on posting the entry to the global event queue. Control then passes to end step 632.

If there is a single network connection, control passes to step 618. In step 618, each network connection may be associated with a plurality of completion queues (CQs). Each CPU may be associated with a single global event queue (EQ) and a MSI-X vector. In step 620, the plurality of completions may be distributed between the plurality of CPUs. In step 622, each of the plurality of completion queues associated with the network connection may be associated with one or more logical unit numbers (LUNs). A task associated with one or more LUNs may be completed within each of the plurality of completion queues associated with the network connection. Optionally, in step 624, a task associated with the I/O request that started in one of the plurality of CPUs may be completed within the same CPU.

In step 626, a plurality of completions associated with the network connection may be posted to one or more CQs associated with the network connection. In step 628, an entry may be posted to the EQ associated with a particular CPU after completions have been posted to one or more CQs associated with the particular CPU. In step 630, the particular CPU may be interrupted via the MSI-X vector based on posting the entry to the global event queue. Control then passes to end step 632.

In accordance with an embodiment of the invention, a method and system for host software concurrent processing of a network connection using multiple central processing units (CPUs) may comprise a network system 400 comprising a plurality of processors or a plurality of central processing units (CPUs), for example, CPU-0 402₀, CPU-1 402₁. . . CPU-N 402_{N} and a NIC 410. After completion of one or more received I/O requests, for example, an iSCSI request, the NIC 410 may be enabled to distribute a plurality of completions among two or more of the plurality of processors, for example, CPU-0 402₀, CPU-1 402₁. . . CPU-N 402_{N}.

Each CPU may be enabled to handle processing for one or more network connections. For example, in case of a single network connection, each of the plurality of CPUs, for example, CPU-0 402₀, CPU-1 402₁. . . , CPU-N 402_{N} may be enabled to handle processing for connection-0. In case of the single network connection, each network connection may be associated with a plurality of completion queues. Each CPU may comprise an event queue (EQ), a MSI-X interrupt and status block, and a completion queue (CQ) associated with a particular connection. For example, CPU-0 402₀ may comprise an EQ-0 404₀, a MSI-X vector and status block 406₀, and a CQ-0 for connection-0 408₀. Similarly, CPU-1 402₁ may comprise an EQ-1 404₁, a MSI-X vector and status block 406₁, and a CQ-1 for connection-0 408₁. CPU-N 402_{N} may comprise an EQ-N 404_{N}, a MSI-X vector and status block 406_{N}, and a CQ-N for connection-0 408_{N}.

The NIC 410 may be enabled to place a notification of one or more completions on at least one of the plurality of completion queues per connection, for example, CQ-0 for connection-0 408₀, CQ-1 for connection-0 408₁. . . , CQ-N for connection-0 408_{N} after completion of one or more received I/O requests. At least one of the plurality of completion queues per connection, for example, CQ-0 for connection-0 408₀, CQ-1 for connection-0 408₁. . . , CQ-N for connection-0 408_{N} may be updated based on the completion of one or more received I/O requests. An entry may be posted to at least one global event queue based on the placement of the notification of one or more completions. For example, an entry may be posted to EQ-0 404₀ based on the placement of the notification of one or more completions to CQ-0 for connection-0 408₀. An entry may be posted to at least one global event queue based on the updating of the completion queues, for example, CQ-0 for connection-0 408₀. At least one of the plurality of CPUs, for example, CPU-0 402₀, CPU-1 402₁. . . , CPU-N 402_{N} associated with the particular global event queue, for example, EQ-0 404₀ may be interrupted utilizing the particular MSI-X, for example, MSI-X vector 406₀ associated with CPU-0 402₀ based on the posting of the entry to the particular global event queue, for example, EQ-0 404₀. The iSCSI target 122 may be enabled to generate at least one response based on the interruption of at least one of the plurality of CPUs, for example, CPU-0 402₀, utilizing the particular MSI-X, for example, MSI-X vector 406₀ associated with CPU-0 402₀.

Each of the plurality of completion queues associated with a particular network connection, for example, CQ-0 for connection-0 408₀, CQ-1 for connection-0 408₁. . . CQ-N for connection-0 408_{N} may be associated with one or more logical unit numbers (LUNs). A task associated with one or more LUNs may be completed within each of the plurality of completion queues associated with the particular network connection, for example, CQ-0 for connection-0 408₀, CQ-1 for connection-0 408₁. . . CQ-N for connection-0 408_{N}. In another embodiment of the invention, a task associated with the I/O request that started in one of the plurality of CPUs, for example, CPU-0 402₀ may be completed within the same CPU, for example, CPU-0 402₀. The HBA may be enabled to generate a fenced response to preserve ordering of responses received by the iSCSI target 122. When a fenced response is received, the HBA may be enabled to determine whether the received responses that were chronologically received before the fenced response are completed to the upper layer before the fenced response is completed. The HBA may also be enabled to determine whether the received responses that were chronologically received after the fenced response are completed to the upper layer after the fenced response is completed. The HBA may be enabled to chronologically process each of the received responses from the iSCSI target 122 based on the generated fenced response.

Another embodiment of the invention may provide a machine-readable storage, having stored thereon, a computer program having at least one code section executable by a machine, thereby causing the machine to perform the steps as described above for host software concurrent processing of a network connection using multiple central processing units (CPUs).

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
in a network system comprising a plurality of processors and a NIC, distributing a plurality of completions associated with a received I/O request among two or more of said plurality of processors for processing.

2. The method according to claim 1, wherein each of said plurality of processors handles processing for at least one network connection and said at least one network connection is associated with a plurality of completion queues.

3. The method according to claim 2, comprising updating at least one of said plurality of completion queues after completion of said received I/O request.

4. The method according to claim 3, wherein each of said plurality of processors is associated with at least one global event queue.

5. The method according to claim 4, comprising communicating an event to said at least one global event queue based on said completion of said received I/O request.

6. The method according to claim 5, comprising posting an entry to said at least one global event queue based on said completion of said received I/O request.

7. The method according to claim 6, comprising interrupting at least one of said plurality of processors based on said posting of said entry to said at least one global event queue.

8. The method according to claim 7, comprising completing said received I/O request based on a received response from an iSCSI target.

9. The method according to claim 8, wherein each of said plurality of completion queues is associated with one or more logical unit numbers (LUNs).

10. The method according to claim 9, comprising completing said received I/O request associated with said one or more LUNs within each of said plurality of completion queues.

11. The method according to claim 8, comprising completing said received I/O request within one of said plurality of processors where processing of said received I/O request started.

12. The method according to claim 8, comprising generating a fenced response in one or more scenarios to preserve ordering of said received responses from said iSCSI target.

13. The method according to claim 12, comprising chronologically processing said received response based on said generated fenced response.

14. The method according to claim 12, wherein said one or more scenarios comprises a task management function (TMF) response, a SCSI response with sense data, a SCSI response with auto contingent allegiance (ACA) active status, an unsolicited NOP-in request, an asynchronous message protocol data unit (PDU) and a reject PDU.

15. A system for processing data, the system comprising:
one or more circuits in a network system comprising a plurality of processors that enables distribution of a plurality of completions associated with a received I/O request among two or more of said plurality of processors for processing.

16. The system according to claim 15, wherein each of said plurality of processors handles processing for at least one network connection and said at least one network connection is associated with a plurality of completion queues.

17. The system according to claim 16, wherein said one or more circuits enables updating of at least one of said plurality of completion queues after completion of said received I/O request.

18. The system according to claim 17, wherein each of said plurality of processors is associated with at least one global event queue.

19. The system according to claim 18, wherein said one or more circuits enables communication of an event to said at least one global event queue based on said completion of said received I/O request.

20. The system according to claim 19, wherein said one or more circuits enables posting of an entry to said at least one global event queue based on said completion of said received I/O request.

21. The system according to claim 20, wherein said one or more circuits enables interruption of at least one of said plurality of processors based on said posting of said entry to said at least one global event queue.

22. The system according to claim 21, wherein said one or more circuits enables completion of said received I/O request based on a received response from an iSCSI target.

23. The system according to claim 22, wherein each of said plurality of completion queues is associated with one or more logical unit numbers (LUNs).

24. The system according to claim 23, wherein said one or more circuits enables completion of said received I/O request associated with said one or more LUNs within each of said plurality of completion queues.

25. The system according to claim 22, wherein said one or more circuits enables completion of said received I/O request within one of said plurality of CPUs where processing of said received I/O request started.

26. The system according to claim 22, wherein said one or more circuits enables generation of a fenced response. in one or more scenarios to preserve ordering of said received responses from said iSCSI target.

27. The system according to claim 26, wherein said one or more circuits enables chronological processing of said received response based on said generated fenced response.

28. The method according to claim 26, wherein said one or more scenarios comprises a task management function (TMF) response, a SCSI response with sense data, a SCSI response with auto contingent allegiance (ACA) active status, an unsolicited NOP-in request, an asynchronous message protocol data unit (PDU) and a reject PDU.

29. The system according to claim 15, comprising a NIC, wherein said NIC comprises said one or more circuits.
